(19) United States
(12) Patent Application Publication
(10) Pub. No.: US 2026/0371281 A1
(43) Pub. Date: Nov. 19, 2026

(54) METHOD, APPARATUS AND COMPUTER PROGRAM

(71) Applicant: Nokia Technologies Oy, Espoo (FI)

(72) Inventors: Philippe GODIN, Massy (FR); Alessio CASATI, WEST MOLESEY (GB); Halit Murat GÜRSU, Munich (DE); Muhammad NASEER-UL-ISLAM, Munich (DE); Ugur Baran ELMALI, Munich (DE); Arled PAPA, Munich (DE); Rajesh Babu NATARAJAN, Bangalore (IN); György Tamás WOLFNER, Budapest (HU); Alexander MILINSKI, Munich (DE); Srinivas BANDI, Bangalore (IN)

(21) Appl. No.: 19/127,900

(22) PCT Filed: Jan. 4, 2024
(86) PCT No.: PCT/EP2024/050119

§ 371 Date: May 7, 2025

(30) Foreign Application Priority Data
Jan. 4, 2023 (IN) 202311000623

(51) Int. Cl. H04W 60/04; H04W 48/18

(52) U.S. Cl. CPC H04W 60/04; H04W 48/18

(57) ABSTRACT

There is provided an apparatus comprising means for receiving, from a network function, first information related to a first area in which a first network slice is supported, wherein the first area is comprised within a tracking area of a registration area of a user equipment. The apparatus also comprising means for determining, when the user equipment moves from the first area to a second area within the registration area, whether to trigger a registration based on the first information.

### FIELD

The present application relates to a method, apparatus, and computer program for a wireless communication system.

### BACKGROUND

A communication system may be a facility that enables communication sessions between two or more entities such as user terminals, base stations/access points and/or other nodes by providing carriers between the various entities involved in the communications path. A communication system may be provided, for example, by means of a communication network and one or more compatible communication devices. The communication sessions may comprise, for example, communication of data for carrying communications such as voice, electronic mail (email), text message, multimedia and/or content data and so on. Non-limiting examples of services provided comprise two-way or multi-way calls, data communication or multimedia services and access to a data network system, such as the Internet.

### SUMMARY

According to an aspect, there is provided an apparatus comprising: means for receiving, from a network function, first information related to a first area in which a first network slice is supported, wherein the first area is comprised within a tracking area of a registration area of a user equipment; and means for determining, when the user equipment moves from the first area to a second area within the registration area, whether to trigger a registration based on the first information.

In an example, the first information comprises an identification of: i) the first network slice, and ii) the first area in which the first network slice is supported in.

In an example, the identification of the first area is a cell identifier, the cell identifier linked to the identification of the first network slice.

In an example, the first network slice is partially supported within the tracking area of the registration area of the user equipment.

In an example, the user equipment is camping in the first area when receiving

In an example, the means for determining comprises: means for using the first information to determine whether to trigger the registration; and means for, in response to determining to trigger the registration, providing a register request message to the network function.

In an example, the means for determining comprises: means for, when the user equipment moves from a first cell of the first area to a second cell of the second area, determining whether the second cell supports the first network slice based on the first information; and means for, in response to determining that the second cell does not support the first network slice, providing a register request message to the network function.

In an example, at least one of: the first area is the first cell, and the second area is the second cell.

In an example, the first information comprises at least one cell identifier of at least one cell of at least one tracking area within the registration area in which first network slice is supported, wherein the least one cell includes a cell in which the user equipment is camping.

In an example, the first information comprises at least one other cell identifier of at least one other cell of at least one tracking area within the registration area in which the first network slice is not supported, wherein the user equipment is camping in a cell away from the at least one other cell.

In an example, the apparatus comprises: means for receiving an allowed network slice assistance information including single-network slice assistance information associated with the first network slice.

In an example, the received single network slice assistance information of the first network slice in the allowed NSSAI is received as part of the first information.

In an example, the first network slice is indicated in the first information by single network slice assistance information that is received in a partially allowed single network slice assistance information.

In an example, the first information comprises: an update indicator, the update indicator causing the user equipment to trigger a registration when the user equipment moves away from the first area.

In an example, at least one of: the first area comprises at least one cell of the registration area, and the second area comprises at least one further cell of the registration area.

In an example, the at least one cell of the first area and the at least one further cell of the second area are different.

In an example, the means for determining comprises: means for, in response to determining that the user equipment has moved out of the first area and based on the received update indicator, providing a register request message to the network function.

In an example, the first information is included in one of: a register accept message, a user equipment configuration update message.

In an example, the apparatus comprises: means for providing, to the network function, a register request message indicating the first network slice, wherein the first information is received in response to the register request message.

In an example, the register accept message comprises an allowed NSSAI comprising second information with a second network slice that is supported in all cells of the registration area.

In an example, at least one of: the first area is a first cell of the registration area, and the second area is a second cell of the registration area.

In an example, the apparatus comprises: means for providing, to the network function, a support indication in a register request message, the support indication indicating that the user equipment supports reception of the first information.

In an example, one of: the apparatus is for the user equipment, the apparatus is comprised in the user equipment, and the apparatus is the user equipment.

According to an aspect, there is provided an apparatus comprising: means for determining, based on a received request from a user equipment, that a first network slice is supported in a first area, wherein the first area is comprised within a tracking area of a registration area of the user equipment; and means for providing, to the user equipment, first information indicating the first area in which the first network slice is supported.

In an example, the first information comprises an identification of: i) the first network slice, and ii) the first area in which the first network slice is supported.

In an example, the identification of the first area is a cell identifier, the cell identifier linked to the identification of the first network slice.

In an example, the first network slice is partially supported within the tracking area of the registration area of the user equipment.

In an example, first information is provided to the user equipment while the user equipment is camping in the first area.

In an example, the apparatus comprises: means for receiving, from the user equipment, a register request message when the user equipment has moved to a second area, the second area away from the first area.

In an example, at least one of: the first area is a first cell of the registration area, and the second area is a second cell of the registration area.

In an example, the first information comprises at least one cell identifier of at least one cell of at least one tracking area within the registration area in which first network slice is supported, wherein the least one cell includes a cell in which the user equipment is camping.

In an example, the first information comprises at least one other cell identifier of at least one other cell of at least one tracking area within the registration area in which the first network slice is not supported, wherein the user equipment is camping in a cell away from the at least one other cell.

In an example, the apparatus comprises: means for providing an allowed network slice selection assistance information including single network slice assistance information associated with the first network slice.

In an example, the received single network slice assistance information of the first network slice in the allowed NSSAI is received as part of the first information.

In an example, the first network slice is indicated in the first information by single network slice assistance information that is provided in a partially allowed single network slice assistance information.

In an example, the first information comprises: an update indicator, the update indicator causing the user equipment to trigger a registration when the user equipment moves away from the first area.

In an example, at least one of: the first area comprises at least one cell of the registration area, and the second area comprises at least one further cell of the registration area.

In an example, the at least one cell of the first area and the at least one further cell of the second area are different.

In an example, the apparatus comprises: means for providing, to the user equipment, a partially rejected network slice assistance information indicating the first network slice, while the user equipment is located in a second area of the registration area.

In an example, the first information is provided within one of: a register accept message, a user equipment configuration update message.

In an example, the apparatus comprises: means for receiving, from the user equipment, a register request message indicating the first network slice.

In an example, the apparatus comprises means for providing an allowed NSSAI comprising second information with a second network slice that is supported in all cells of the registration area.

In an example, the apparatus comprises: means for receiving, from the user equipment, a support indication indicating that the user equipment supports reception of the first information; and means for providing the first information based on the received support indication.

In an example, one of: the apparatus is for a network function, the apparatus is comprised in the network function, and the apparatus is the network function.

According to an aspect, there is provided an apparatus comprising: at least one processor, and at least one memory storing instructions that, when executed by the one or more processors, cause the apparatus to perform: receiving, from a network function, first information related to a first area in which a first network slice is supported, wherein the first area is comprised within a tracking area of a registration area of a user equipment; and determining, when the user equipment moves from the first area to a second area within the registration area, whether to trigger a registration based on the first information.

In an example, the first information comprises an identification of: i) the first network slice, and ii) the first area in which the first network slice is supported in.

In an example, the identification of the first area is a cell identifier, the cell identifier linked to the identification of the first network slice.

In an example, the first network slice is partially supported within the tracking area of the registration area of the user equipment.

In an example, the user equipment is camping in the first area when receiving the first information.

In an example, the determining comprises: using the first information to determine whether to trigger the registration; and in response to determining to trigger the registration, providing a register request message to the network function.

In an example, the determining comprises: when the user equipment moves from a first cell of the first area to a second cell of the second area, determining whether the second cell supports the first network slice based on the first information; and in response to determining that the second cell does not support the first network slice, providing a register request message to the network function.

In an example, at least one of: the first area is the first cell, and the second area is the second cell.

In an example, the first information comprises at least one cell identifier of at least one cell of at least one tracking area within the registration area in which first network slice is supported, wherein the least one cell includes a cell in which the user equipment is camping.

In an example, the first information comprises at least one other cell identifier of at least one other cell of at least one tracking area within the registration area in which the first network slice is not supported, wherein the user equipment is camping in a cell away from the at least one other cell.

In an example, the apparatus is caused to perform: receiving an allowed network slice assistance information including single-network slice assistance information associated with the first network slice.

In an example, the received single network slice assistance information of the first network slice in the allowed NSSAI is received as part of the first information.

In an example, the first network slice is indicated in the first information by single network slice assistance information that is received in a partially allowed single network slice assistance information.

In an example, the first information comprises: an update indicator, the update indicator causing the user equipment to trigger a registration when the user equipment moves away from the first area.

In an example, at least one of: the first area comprises at least one cell of the registration area, and the second area comprises at least one further cell of the registration area.

In an example, the at least one cell of the first area and the at least one further cell of the second area are different.

In an example, the determining comprises: in response to determining that the user equipment has moved out of the first area and based on the received update indicator, providing a register request message to the network function.

In an example, the first information is included in one of: a register accept message, a user equipment configuration update message.

In an example, the apparatus is caused to perform: providing, to the network function, a register request message indicating the first network slice, wherein the first information is received in response to the register request message.

In an example, the register accept message comprises an allowed NSSAI comprising second information with a second network slice that is supported in all cells of the registration area.

In an example, at least one of: the first area is a first cell of the registration area, and the second area is a second cell of the registration area.

In an example, the apparatus is caused to perform: providing, to the network function, a support indication in a register request message, the support indication indicating that the user equipment supports reception of the first information.

In an example, one of: the apparatus is for the user equipment, the apparatus is comprised in the user equipment, and the apparatus is the user equipment.

According to an aspect, there is provided an apparatus comprising: at least one processor, and at least one memory storing instructions that, when executed by the one or more processors, cause the apparatus to perform: determining, based on a received request from a user equipment, that a first network slice is supported in a first area, wherein the first area is comprised within a tracking area of a registration area of the user equipment; and providing, to the user equipment, first information indicating the first area in which the first network slice is supported.

In an example, the first information comprises an identification of: i) the first network slice, and ii) the first area in which the first network slice is supported.

In an example, the identification of the first area is a cell identifier, the cell identifier linked to the identification of the first network slice.

In an example, the first network slice is partially supported within the tracking area of the registration area of the user equipment.

In an example, first information is provided to the user equipment while the user equipment is camping in the first area.

In an example, the apparatus is caused to perform: receiving, from the user equipment, a register request message when the user equipment has moved to a second area, the second area away from the first area.

In an example, at least one of: the first area is a first cell of the registration area, and the second area is a second cell of the registration area.

In an example, the first information comprises at least one cell identifier of at least one cell of at least one tracking area within the registration area in which first network slice is supported, wherein the least one cell includes a cell in which the user equipment is camping.

In an example, the first information comprises at least one other cell identifier of at least one other cell of at least one tracking area within the registration area in which the first network slice is not supported, wherein the user equipment is camping in a cell away from the at least one other cell.

In an example, the apparatus is caused to perform: providing an allowed network slice selection assistance information including single network slice assistance information associated with the first network slice.

In an example, the received single network slice assistance information of the first network slice in the allowed NSSAI is received as part of the first information.

In an example, the first network slice is indicated in the first information by single network slice assistance information that is provided in a partially allowed single network slice assistance information.

In an example, the first information comprises: an update indicator, the update indicator causing the user equipment to trigger a registration when the user equipment moves away from the first area.

In an example, at least one of: the first area comprises at least one cell of the registration area, and the second area comprises at least one further cell of the registration area.

In an example, the at least one cell of the first area and the at least one further cell of the second area are different.

In an example, the apparatus is caused to perform: providing, to the user equipment, a partially rejected network slice assistance information indicating the first network slice, while the user equipment is located in a second area of the registration area.

In an example, the first information is provided within one of: a register accept message, a user equipment configuration update message.

In an example, the apparatus is caused to perform: receiving, from the user equipment, a register request message indicating the first network slice.

In an example, the apparatus is caused to perform: providing an allowed NSSAI comprising second information with a second network slice that is supported in all cells of the registration area.

In an example, the apparatus is caused to perform: receiving, from the user equipment, a support indication indicating that the user equipment supports reception of the first information; and providing the first information based on the received support indication.

In an example, one of: the apparatus is for a network function, the apparatus is comprised in the network function, and the apparatus is the network function.

According to an aspect, there is provided a method comprising: receiving, from a network function, first information related to a first area in which a first network slice is supported, wherein the first area is comprised within a tracking area of a registration area of a user equipment; and determining, when the user equipment moves from the first area to a second area within the registration area, whether to trigger a registration based on the first information.

In an example, the first information comprises an identification of: i) the first network slice, and ii) the first area in which the first network slice is supported in.

In an example, the identification of the first area is a cell identifier, the cell identifier linked to the identification of the first network slice.

In an example, the first network slice is partially supported within the tracking area of the registration area of the user equipment.

In an example, the user equipment is camping in the first area when receiving the first information.

In an example, the determining comprises: using the first information to determine whether to trigger the registration; and in response to determining to trigger the registration, providing a register request message to the network function.

In an example, the determining comprises: when the user equipment moves from a first cell of the first area to a second cell of the second area, determining whether the second cell supports the first network slice based on the first information; and in response to determining that the second cell does not support the first network slice, providing a register request message to the network function.

In an example, at least one of: the first area is the first cell, and the second area is the second cell.

In an example, the first information comprises at least one cell identifier of at least one cell of at least one tracking area within the registration area in which first network slice is supported, wherein the least one cell includes a cell in which the user equipment is camping.

In an example, the first information comprises at least one other cell identifier of at least one other cell of at least one tracking area within the registration area in which the first network slice is not supported, wherein the user equipment is camping in a cell away from the at least one other cell.

In an example, the method comprises: receiving an allowed network slice assistance information including single-network slice assistance information associated with the first network slice.

In an example, the received single network slice assistance information of the first network slice in the allowed NSSAI is received as part of the first information.

In an example, the first network slice is indicated in the first information by single network slice assistance information that is received in a partially allowed single network slice assistance information.

In an example, the first information comprises: an update indicator, the update indicator causing the user equipment to trigger a registration when the user equipment moves away from the first area.

In an example, at least one of: the first area comprises at least one cell of the registration area, and the second area comprises at least one further cell of the registration area.

In an example, the at least one cell of the first area and the at least one further cell of the second area are different.

In an example, the determining comprises: in response to determining that the user equipment has moved out of the first area and based on the received update indicator, providing a register request message to the network function.

In an example, the first information is included in one of: a register accept message, a user equipment configuration update message.

In an example, the method comprises: providing, to the network function, a register request message indicating the first network slice, wherein the first information is received in response to the register request message.

In an example, the register accept message comprises an allowed NSSAI comprising second information with a second network slice that is supported in all cells of the registration area.

In an example, at least one of: the first area is a first cell of the registration area, and the second area is a second cell of the registration area.

In an example, the method comprises: providing, to the network function, a support indication in a register request message, the support indication indicating that the user equipment supports reception of the first information.

In an example, the method is performed by the user equipment.

According to an aspect, there is provided a method comprising: determining, based on a received request from a user equipment, that a first network slice is supported in a first area, wherein the first area is comprised within a tracking area of a registration area of the user equipment; and providing, to the user equipment, first information indicating the first area in which the first network slice is supported.

In an example, the first information comprises an identification of: i) the first network slice, and ii) the first area in which the first network slice is supported.

In an example, the identification of the first area is a cell identifier, the cell identifier linked to the identification of the first network slice.

In an example, the first network slice is partially supported within the tracking area of the registration area of the user equipment.

In an example, first information is provided to the user equipment while the user equipment is camping in the first area.

In an example, the method comprises: receiving, from the user equipment, a register request message when the user equipment has moved to a second area, the second area away from the first area.

In an example, at least one of: the first area is a first cell of the registration area, and the second area is a second cell of the registration area.

In an example, the first information comprises at least one cell identifier of at least one cell of at least one tracking area within the registration area in which first network slice is supported, wherein the least one cell includes a cell in which the user equipment is camping.

In an example, the first information comprises at least one other cell identifier of at least one other cell of at least one tracking area within the registration area in which the first network slice is not supported, wherein the user equipment is camping in a cell away from the at least one other cell.

In an example, the method comprises: providing an allowed network slice selection assistance information including single network slice assistance information associated with the first network slice.

In an example, the received single network slice assistance information of the first network slice in the allowed NSSAI is received as part of the first information.

In an example, the first network slice is indicated in the first information by single network slice assistance information that is provided in a partially allowed single network slice assistance information.

In an example, the first information comprises: an update indicator, the update indicator causing the user equipment to trigger a registration when the user equipment moves away from the first area.

In an example, at least one of: the first area comprises at least one cell of the registration area, and the second area comprises at least one further cell of the registration area.

In an example, the at least one cell of the first area and the at least one further cell of the second area are different.

In an example, the method comprises: providing, to the user equipment, a partially rejected network slice assistance information indicating the first network slice, while the user equipment is located in a second area of the registration area.

In an example, the first information is provided within one of: a register accept message, a user equipment configuration update message.

In an example, the method comprises: receiving, from the user equipment, a register request message indicating the first network slice.

In an example, the method comprises: providing an allowed NSSAI comprising second information with a second network slice that is supported in all cells of the registration area.

In an example, the method comprises: receiving, from the user equipment, a support indication indicating that the user equipment supports reception of the first information; and providing the first information based on the received support indication.

In an example, the method is performed by the network function.

According to an aspect, there is provided a computer program comprising instructions, which when executed by an apparatus, cause the apparatus to perform: receiving, from a network function, first information related to a first area in which a first network slice is supported, wherein the first area is comprised within a tracking area of a registration area of a user equipment; and determining, when the user equipment moves from the first area to a second area within the registration area, whether to trigger a registration based on the first information.

According to an aspect, there is provided a computer program comprising instructions, which when executed by an apparatus, cause the apparatus to perform: determining, based on a received request from a user equipment, that a first network slice is supported in a first area, wherein the first area is comprised within a tracking area of a registration area of the user equipment; and providing, to the user equipment, first information indicating the first area in which the first network slice is supported.

According to an aspect, there is provided a computer program comprising instructions stored thereon for performing at least the following: receiving, from a network function, first information related to a first area in which a first network slice is supported, wherein the first area is comprised within a tracking area of a registration area of a user equipment; and determining, when the user equipment moves from the first area to a second area within the registration area, whether to trigger a registration based on the first information.

According to an aspect, there is provided a computer program comprising instructions stored thereon for performing at least the following: determining, based on a received request from a user equipment, that a first network slice is supported in a first area, wherein the first area is comprised within a tracking area of a registration area of the user equipment; and providing, to the user equipment, first information indicating the first area in which the first network slice is supported.

A computer product stored on a medium may cause an apparatus to perform the methods as described herein.

A non-transitory computer readable medium comprising program instructions, that, when executed by an apparatus, cause the apparatus to perform the methods as described herein.

An electronic device may comprise apparatus as described herein.

In the above, various aspects have been described. It should be appreciated that further aspects may be provided by the combination of any two or more of the various aspects described above.

Various other aspects and further embodiments are also described in the following detailed description and in the attached claims.

According to some aspects, there is provided the subject matter of the independent claims. Some further aspects are defined in the dependent claims. The embodiments that do not fall under the scope of the claims are to be interpreted as examples useful for understanding the disclosure.

### LIST OF ABBREVIATIONS

AF: Application Function
AMF: Access and Mobility Management Function
AN: Access Network
BS: Base Station
CLRI: Cell level registration information
CN: Core Network
DL: Downlink
eNB: eNodeB
gNB: gNodeB
IIoT: Industrial Internet of Things
LTE: Long Term Evolution
MS: Mobile Station
MRU: Mobility registration update
NAS: Non-access stratum
NEF: Network Exposure Function
NGAP: Next Generation application protocol
NG-RAN: Next Generation Radio Access Network
NF: Network Function
NR: New Radio
NRF: Network Repository Function
NSSAI: Network slice selection association information
NW: Network
PLMN: Public Land Mobile Network
RA: Registration area
RAN: Radio Access Network
RF: Radio Frequency
SMF: Session Management Function
S-NSSAI: Single-network slice selection association information
TA: Tracking area
UE User Equipment
UDR: Unified Data Repository
UDM: Unified Data Management
UL: Uplink
UPF: User Plane Function
3GPP: 3^{rd} Generation Partnership Project
5G: 5^{th} Generation
5GC: 5G Core network
5G-AN: 5G Radio Access Network
5GS: 5G System

### DESCRIPTION OF FIGURES

Embodiments will now be described, by way of example only, with reference to the accompanying Figures in which:
FIG. 1 shows a schematic representation of a 5G system;
FIG. 2 shows a schematic representation of a control apparatus;
FIG. 3 shows a schematic representation of a terminal;
FIG. 4 shows an example signalling diagram between a user equipment and network entities;
FIG. 5 shows another example signalling diagram between a user equipment and network entities;
FIG. 6 shows an example method flow diagram performed by an apparatus;
FIG. 7 shows another example method flow diagram performed another apparatus; and
FIG. 8 shows a schematic representation of a non-volatile memory medium storing instructions which when executed by a processor allow a processor to perform one or more of the steps of the methods of FIGS. 6 and 7.

### DETAILED DESCRIPTION

Before explaining in detail some examples of the present disclosure, certain general principles of a wireless communication system and mobile communication devices are briefly explained with reference to FIGS. 1 to 3 to assist in understanding the technology underlying the described examples.

In a wireless communication system 100, such as that shown in FIG. 1, mobile communication devices/terminals or user apparatuses, and/or user equipments (UE), and/or machine-type communication devices 102 are provided wireless access via at least one base station (not shown) or similar wireless transmitting and/or receiving node or point. A communication device is provided with an appropriate signal receiving and transmitting apparatus for enabling communications, for example enabling access to a communication network or communications directly with other devices. The communication device may access a carrier provided by a station or access point, and transmit and/or receive communications on the carrier.

In the following certain examples are explained with reference to mobile communication devices capable of communication via a wireless cellular system and mobile communication systems serving such mobile communication devices. Before explaining in detail the examples of the disclosure, certain general principles of a wireless communication system, access systems thereof, and mobile communication devices are briefly explained with reference to FIGS. 1, 2 and 3 to assist in understanding the technology underlying the described examples.

FIG. 1 shows a schematic representation of a wireless communication system 100. The wireless communication system 100 may comprise one more devices 102 such as user equipments (UEs), or terminals. The wireless communication system 100 may also comprise a 5G system (5GS), as shown in Figure. The 5GS comprises a 5G radio access network (5G-RAN) 106, a 5G core network (5GC) 104 comprising one or more network functions (NF), one or more application functions (AFs) 108, and one or more data networks (DNs) 110.

The 5G-RAN 106 may comprise one or more gNodeB (gNB) distributed unit (DU) functions connected to one or more gNodeB (gNB) centralized unit (CU) functions.

The 5GC 104 may comprise an access management function (AMF) 112, a session management function (SMF) 114, an authentication server function (AUSF) 116, a user data management (UDM) 118, a user plane function (UPF) 120, a network exposure function (NEF) 122 and/or other NFs. Some of the examples as shown below may be applicable to 3GPP 5G standards. However, some examples may also be applicable to 5G-advanced, 4G, 3G and other 3GPP standards.

In a wireless communication system 100, such as that shown in FIG. 1, mobile communication devices/terminals or user apparatuses, and/or user equipments (UE), and/or machine-type communication devices are provided with wireless access via at least one base station or similar wireless transmitting and/or receiving node or point. The terminal is provided with an appropriate signal receiving and transmitting apparatus for enabling communications, for example enabling access to a communication network or communications directly with other devices. The communication device may access a carrier provided by a base station or access point, and transmit and/or receive communications on the carrier.

FIG. 2 illustrates an example of a control apparatus 200 for controlling a function of the 5G-RAN or the 5GC as illustrated on FIG. 1. The control apparatus may comprise at least one random access memory (RAM) 211a, at least one read only memory (ROM) 211b, at least one processor 212, 213 and an input/output interface 214. The at least one processor 212, 213 may be coupled to the RAM 211a and the ROM 211b. The at least one processor 212, 213 may be configured to execute an appropriate software code 215. The software code 215 may for example allow to perform one or more steps to perform one or more of the present aspects. The software code 215 may be stored in the ROM 211b. The control apparatus 200 may be interconnected with another control apparatus 200 controlling another function of the 5G-AN or the 5GC. In some examples, each function of the 5G-AN or the 5GC comprises a control apparatus 200. In alternative examples, two or more functions of the 5G-AN or the 5GC may share a control apparatus.

FIG. 3 illustrates an example of a terminal 300, such as the terminal illustrated on FIG. 1. The terminal 300 may be provided by any device capable of sending and receiving radio signals. Non-limiting examples comprise a user equipment, a mobile station (MS) or mobile device such as a mobile phone or what is known as a ‘smart phone’, a computer provided with a wireless interface card or other wireless interface facility (e.g., USB dongle), a personal data assistant (PDA) or a tablet provided with wireless communication capabilities, a machine-type communications (MTC) device, a Cellular Internet of things (CloT) device or any combinations of these or the like. The terminal 300 may provide, for example, communication of data for carrying communications. The communications may be one or more of voice, electronic mail (email), text message, multimedia, data, machine data and so on.

The terminal 300 may receive signals over an air or radio interface 307 via appropriate apparatus for receiving and may transmit signals via appropriate apparatus for transmitting radio signals. In FIG. 3, a transceiver apparatus is designated schematically by block 306. The transceiver apparatus 306 may be provided for example by means of a radio part and associated antenna arrangement. The antenna arrangement may be arranged internally or externally to the mobile device.

The terminal 300 may be provided with at least one processor 301, at least one memory ROM 302a, at least one RAM 302b and other possible components 303 for use in software and hardware aided execution of tasks it is designed to perform, including control of access to and communications with access systems and other communication devices. The at least one processor 301 is coupled to the RAM 302b and the ROM 302a. The at least one processor 301 may be configured to execute an appropriate software code 308. The software code 308 may for example allow to perform one or more of the present aspects. The software code 308 may be stored in the ROM 302a.

The processor, storage and other relevant control apparatus may be provided on an appropriate circuit board and/or in chipsets. This feature is denoted by reference 304. The device may optionally have a user interface such as keypad 305, touch sensitive screen or pad, combinations thereof or the like. Optionally one or more of a display, a speaker and a microphone may be provided depending on the type of the device.

Network slicing is a feature of 5G networks. A network slice is a logical end-to-end network that can be dynamically created. A UE may have access to multiple slices from the same gNB. Each network slice may serve a particular service type.

A network slice is defined within a public land mobile network (PLMN) and includes the 5GC and 5G RAN control plane and user plane. The network slices are identified using single network slice selection assistance information (S-NSSAI). NSSAI is a collection of S-NSSAls. Currently, 3GPP allows up to eight S-NSSAIs in the NSSAI. This means that a single UE may be served by at most eight network slices at a time.

There are a number of types of NSSAls. ‘Subscribed S-NSSAIs’ are stored in the UDM, and the 5GC uses this as a default when the UE does not send a requested NSSAI. ‘Configured NSSAI’ is a configuration from the PLMN, the PLMN configuring a UE with one or more configured NSSAls. The UE uses this as its default NSSAI. This may be the same as the ‘Subscribed S-NSSAIs’. ‘Allowed NSSAI’ is a group assigned by the 5GC and is valid in a registration area, or the PLMN, over a given access type. There may be a maximum of eight network slices within an allowed NSSAI. Using all eight network sluices would require the UE to establish eight protocol data unit (PDU) sessions. The allowed NSSAI may be signalled to a gNB using next generation application protocol (NGAP) initial context setup request message. The gNB may use this information when allocating resources for the UE. ‘Requested NSSAI’ may comprise either the ‘configured’ or ‘allowed’ NSSAI, or a combination of both. The UE sends a ‘requested NSSAI’ in RRC setup complete messages and/or non-access stratum (NAS) registration request messages.

An access & mobility management function (AMF) or network slice selection function (NSSF), may receive a requested NSSAI. When it receives the requested NSSAI, the AMF/NSSF evaluates the S-NSSAls of the HPLMN using any received NSSRG information for these S-NSSAls, in order to determine whether the requested NSSAI can be provided together in the ‘allowed NSSAI’.

A UE may be informed of an ‘Allowed NSSAI’ which is a list of network slices uniformly available in the whole registration area (RA) of the UE. The registration area is made up of list of tracking areas (TAs). A TA is a group of cells.

A UE may be informed of a ‘Partially Rejected S-NSSAI’ by a network. The ‘Partially Rejected S-NSSAI’ may be associated with list of TAs, and (if applicable) cells, where a slice ‘x’ is unsupported. This determines that the UE may trigger a register registration when UE enters such a cell/area.

A UE may be informed of a ‘Partially Allowed S-NSSAI’ by a network. The ‘Partially Allowed S-NSSAI’ may be associated with list of TAs, and (if applicable) cells, where a slice ‘x’ is supported. A UE does not signal when the UE enters, or exits, the cells/area. The ‘Partially Allowed S-NSSAI’ may be used by the UE to determine where the UE can expect a service request to be successful. The ‘Partially Allowed S-NSSAI’ may also be used to determine where the slice can be used. For example, to establish a PDU session or send data over a PDU session if established.

The reception of the ‘Partially Rejected S-NSSAI’ and the ‘Partially Allowed S-NSSAI’ at a UE can be useful, as it can help the UE to determine which network slices are available in different areas or cells. However, a number of associated problems have also been determined.

For example, a network slice (e.g. slice 3, S-NSSAI=3) is supported in only one cell (e.g. cell 1) of a first tracking area (TA1) of a registration area. In the example, TA1 comprises other cells (e.g. cells 2 to 5), but slice 3 is not supported on those cells. In this way, it may be said that slice 3 is partially supported in TA1 (or partially supported in the RA). When a UE determines to register with the network for one or more network slices, the UE provides a ‘Register Request’ message to the network. The ‘Register Request’ message may identify the one or more network slices. The UE may receive response from the network, which may be a ‘Register Accept’ message. The ‘Register Accept’ message may identify which network slices are allowed or rejected.

In the example, TA1 covers Ottawa in Canada, while cell 1 of TA1 covers an office building in Ottawa. Cell 1 supports slice 3. A UE may register for slice 3 by sending a request for a protocol data unit (PDU) session of slice 3 while located in the office building in cell 1. The request is accepted by the network as the UE is located in the office building (i.e. within cell 1). The UE may then go to into radio resource control (RRC) idle mode with the existing PDU session.

A ‘Register Accept’ message received by the UE from the network will not comprise a ‘Partially rejected S-NSSAI’ for slice 3 because slice 3 is supported in the office building (i.e. where the UE is located). The ‘Register Accept’ may only contain ‘Allowed NSSAI’ or ‘Partially Allowed NSSAI’. If an ‘Allowed NSSAI’ is comprised in the ‘Register Accept’ message to UE, the UE will register again with the network only when exiting the RA. If a ‘Partially Allowed NSSAI’ is included in the ‘Register Accept’, even though the office building's cell 1 is included as partially allowed for slice 3) the UE will not signal when exiting cell 1.

As a result, there is no way for the network to know when the UE exits the cell 1 of the office building in Ottawa, and that slice 3 is no longer available for the UE. This means that the UE remains registered for slice 3 in the full TA (Ottawa) even though the UE can only access slice 3 in the cell 1 of the office building.

This leads to problems when the UE has exited cell 1. For example, the handling of mobile-terminated (MT) calls (e.g. paging), leads to wasted/useless paging in the RA when the UE has left the office building/cell 1. Furthermore, there are allocations for a maximum number of UEs/PDU sessions for each network slice. In this way, the UE remains registered for slice 3 even outside cell 1 of the office building, even though the UE is not eligible to use this network slice. This means that if a maximum number of UEs for slice 3 has been reached, or max number of PDU sessions for slice 3 has been reached, this will prevent other UEs from registering with/using slice 3.

In the following examples, “partially supported” means that the network slice is supported in at least one cell in a TA, but not supported in at least one other cell in a TA1 of an RA. For example, TA1 comprises cells 1 to 5. ‘Slice 3’ is supported (only) in cell 1 of TA1. ‘Slice 3’ is not supported in cells 2 to 5 of TA1. In this way, for ‘slice 3’ it can be said that this network slice is partially supported in TA1. Alternatively, when TA1=RA1, it can be said that this network slice is partially supported in RA1.

One or more of the following examples aims to address one or more of the problems identified above.

In examples, there is provided an apparatus (e.g. a UE) configured to receive, from a network function (e.g. an AMF), first information related a first area in which a first network slice is supported, wherein the first area is comprised within a tracking area of a registration area of the UE. The apparatus also configured to determine, when the UE moves from the first area to a second area within the registration area, whether to trigger a registration based on the first information.

This will be described in more detail below.

In a first example, a UE checks at each cell change (e.g. a handover) whether the UE has exited a certain cell, or cells, according to cell information received, for example, as first information (or included in the first information). An example of cell information may be a cell identifier such as ‘new’ cell-level registration information (CLRI). In the following examples reference will be made to CLRI. However, any other type of information indicating a cell, or a cell ID, may be also used in the described procedures.

When the UE is located in “cell 1” of a first tracking area, “TA1”, the UE registers for a network slice called “slice 3”, which is only available in a subset of cells of “TA1”. Said another way, “slice 3” is available in one or more cells of TA1 including “cell 1” but not in all of the cells of “TA1”. In response to the received registration message, a network function (e.g. an AMF) includes in a ‘register accept’ message, towards the UE, ‘new’ additional cell-level registration information (CLRI). The CLRI includes a list of cells in which “slice 3” is supported. In other examples, the CLRI includes a list of cells in which “slice 3” is not supported. The CLRI may indicate whether the slice is supported, or not supported, depending on which way is more efficient from encoding standpoint in a given TA. This is in addition to the ‘legacy’ RA which comprises a list of TAs only (in this example, at least TA1).

In this first example, the UE supports the decoding of the CLRI. The UE considers the list of cells included in the received CLRI as a new criteria for checking, at each cell change, whether the UE should trigger a registration/registration procedure. The registration procedure may be found in TS 23.502 clause 4.2.2.2.2. The registration may comprise a non-access stratum (NAS) mobility registration update (MRU) procedure. This means that a UE supporting the received CLRI checks, at every cell change (e.g. a cell re-selection, or handover), whether the UE has exited an area comprising the list of cells of the “CLRI”. If the UE has exited the area of cells, the UE sends an NAS register request message. The AMF then replies with a register accept message including an updated registration area (RA) whereby “slice 3” is no longer be in the Allowed NSSAI.

For a UE that does not support the decoding of the CLRI, the non-supporting UE will continue to read the legacy RA included in the register accept message comprising entire TAs. The non-supporting UE will ignore the received CLRI.

This first example is described in more detail alongside FIG. 4.

FIG. 4 shows an example signalling diagram between a user equipment and network entities.

At S401, the UE provides a message to a network function. The message is provided via a first cell (“cell 1”). The network function may be, for example, an AMF. In other examples, the network function is another suitable network function. In the following steps, the NF will be referred to as the AMF.

The message may be a register request message. The message indicates a request for network slice 1 (“slice 1”), and network slice 3 (“slice”). It should be understood that slices 1 and 3 are requested as an example only. In other examples, more or less than two network slices are requested.

When providing the message, the UE is located in/camping in cell 1. In this example, cell 1 supports slices 1 and 3. Cell 1 is comprised within a first TA (“TA1”) of a first RA (“RA1”). Slice 1 is supported throughout TA1.

In this example, TA1=RA1. In other examples, RA1 comprises TA1 in addition to one or more further TAs.

At S402, the AMF receives the message from the UE. The AMF has access to information that TA1 supports slice 1 (throughout TA1). Cell 1 of TA1 also supports slice 3. In this way, slice 3 is partially supported in TA1.

The AMF determines that slice 3 (as requested by the UE in the message) is not supported in the whole of TA1, where UE is located. The AMF determines that slice 3 is supported in one or more cells of TA1, including cell 1.

At S403, the AMF provides a response message to the UE. The response message is provided via cell 1 (i.e. the cell that the UE is camping in).

The information comprised within the response message is dependent on the message received from the UE, and the location of the UE.

The response message comprises first information related to i) slice 3, and ii) an area in which the slice 3 is supported. In an example, the first information comprises an identification of: i) the first network slice, and ii) the first area in which the first network slice is supported in.

In this example, slice 3 is supported in cell 1. Slice 3 is not supported in any other cells of TA1/RA1.

The first information related to i) slice 3, and ii) the area in which the slice 3 is supported may comprise CLRI for slice 3. The CLRI comprises a list of cells of TA1 where slice 3 is supported. In this example, the list includes only cell 1. The CLRI may also comprise an associated CLRI Allowed NSSAI which comprises slice 3. In this example, CLRI Allowed NSSAI in CLRI=slices 1, 3.

The first information may also identify that slice 1 is supported throughout TA1. The identification of slice 1 may be comprised within Allowed NSSAI.

The first information may also indicate that the TA1 is equal to RA1 (i.e. TA1=RA1).

At S404, the UE receives the response message comprising the first information. The UE may store the first information at the UE, or at a location accessible to the UE. The UE may store the first information when the UE supports the decoding of CLRI. In some examples, a non-supporting UE ignores the first information.

For this example of FIG. 4 it is assumed that the UE does support CLRI.

The UE moves away from cell 1. The UE moves to a second cell (“cell 2”), in this example. Cell 2 is comprised within TA1/RA1.

The UE determines, when the UE moves from cell 1 to a cell 2 within the registration area, whether to trigger a registration based on the received first information.

The UE may determine at each cell re-selection/handover whether the re-selected cell is part of the CLRI. When the re-selected cell is not part of the CLRI, the UE determines to triggers a registration update. In this example, cell 2 does not support slice 3. This is indicated in the first information because the first information indicates that only cell 1 supports slice 3.

In other examples, when the UE moves to another cell which also supports slice 3, the UE will not trigger registration.

At S405, in response to determining to trigger registration, the UE provides a further message to the AMF. The further message is provided to the UE via cell 2.

The further message may be part of an MRU procedure. The MRU procedure comprises sending the further message. The further message may be a register request message.

The further message comprises an indication at least one network slice that is requested for the UE. For example, the further message indicates a request for network slice 1 (“slice 1”), and network slice 3 (“slice”). It should be understood that slices 1 and 3 are requested as an example only. In other examples, more or less than two network slices are requested.

At S406, the AMF provides a further response message to the UE, via cell 2. The further response message may be a register accept message.

The further response message comprises a partially rejected NSSAI with slice 3, cell 1 of TA1. This is because the UE is currently located at/camping in cell 2, wherein cell 2 does not support slice 3.

The further response message also comprises Allowed NSSAI with slice 1. The further response message also indicates that RA1=TA1.

It should be understood that one or more of the steps shown in FIG. 4 may not be performed in some examples, or may be performed in a different order.

In some examples, the UE provides an indication to the network function that the UE supports CLRI decoding.

In a second example, a UE is provided with an MRU indicator that is associated with a Partially Allowed S-NSSAI.

When the UE is located in “cell 1” of a first tracking area, “TA1”, the UE registers for a network slice called “slice 3”, which is only available in a subset of cells of “TA1”. Said another way, “slice 3” is available in one or more cells of TA1 including “cell 1” but not in all of the cells of “TA1”.

In response to the registration message, the AMF indicates in a register accept message the “slice 3” (S-NSSAI 3) as a partially allowed S-NSSAI. The register accept message also indicating an associated area where “slice 3” is supported. The associated area includes TA1, cell 1. The associated area may also comprise further cells. The AMF also includes in the register accept message, for the partially allowed slice 3, a ‘new’ MRU indicator indicating that a UE should trigger registration when exiting the associated area where the partially allowed slice 3 is supported.

The associated area may alternatively be referred to as an area of service. The area of service being an area where a UE can access a particular network slice.

A UE that supports the MRU Indicator will trigger the registration procedure when exiting the area of the partially allowed slice 3. A UE that does not support the MRU indicator may ignore the MRU Indicator.

This second example is described in more detail alongside FIG. 5.

FIG. 5 shows another example signalling diagram between a user equipment and network entities.

At S501, the UE provides a message to a network function. The message is provided via a first cell (“cell 1”). The network function may be, for example, an AMF. In other examples, the network function is another suitable network function. In the following steps, the NF will be referred to as the AMF.

The message may be a register request message. The message indicates a request for network slice 1 (“slice 1”), and network slice 3 (“slice”). It should be understood that slices 1 and 3 are requested as an example only. In other examples, more or less than two network slices are requested.

When providing the message, the UE is located in/camping in cell 1. In this example, cell 1 supports slices 1 and 3. Cell 1 is comprised within a first TA (“TA1”) of a first RA (“RA1”). Slice 1 is supported throughout TA1.

In this example, TA1=RA1. In other examples, RA1 comprises TA1 in addition to one or more further TAs.

At S502, the AMF receives the message from the UE. The AMF has access to information that TA1 supports slice 1 (throughout TA1). Cell 1 of TA1 also supports slice 3. In this way, slice 3 is partially supported in TA1.

The AMF determines that slice 3 (as requested by the UE in the message) is not supported in the whole of TA1, where UE is located. The AMF determines that slice 3 is supported in one or more cells of TA1, including cell 1.

The AMF has access to information that TA1 is equal to RA1. Said another way, TA1 is the only TA of RA1.

At S503, the AMF provides a response message to the UE. The response message is provided via cell 1 (i.e. the cell that the UE is camping in).

The information comprised within the response message is dependent on the message received from the UE, and the location of the UE.

The response message comprises first information related to i) slice 3, and ii) an area in which the slice 3 is supported. In this example, slice 3 is supported in cell 1. Slice 3 is not supported in any other cells of TA1/RA1.

The first information related to i) slice 3, and ii) the area in which the slice 3 is supported may comprise a partially allowed NSSAI indicating slice 3 in cell 1 of TA1. The indication of slice 3 may comprise S-NSSAI 3. The partially allowed NSSAI indicating slice 3 in cell 1 of TA1 may comprise an associated area where slice 3 is supported. In this example of FIG. 5, the associated area is cell 1. In other examples, the associated area may be a plurality of cells within RA1.

The first information may also comprise an indicator. The indicator is associated with/linked to slice 3. The indicator may be named an MRU indicator. It should be understood that any suitable name may be given to the indicator in other examples. The indicator indicates that the UE should trigger registration when the user equipment moves out of the associated area.

At 504, the UE receives the response message comprising the first information. The UE may store the first information (including the MRU indicator) at the UE, or at a location accessible to the UE. The UE may store the first information when the UE supports the MRU indicator. In some examples, a non-supporting UE ignores the first information including the MRU indicator.

For this example of FIG. 5 it is assumed that the UE does support the MRU indicator.

The UE moves away from cell 1. As the associated area consists of cell 1, when the UE moves away from cell 1, the UE is moving out of the associated area.

The UE moves to a second cell (“cell 2”), in this example. Cell 2 is comprised within TA1/RA1. However, cell 2 is not comprised within the associated area.

The UE determines, when the UE moves out of the associated area (i.e. out of cell 1) within the registration area, whether to trigger a registration based on the received first information. The determination is also based on the presence of the MRU indicator.

In the example of FIG. 5, as the UE exits the associated area with the partially allowed slice 3 and the UE supports the MRU Indicator, the UE determines to trigger a registration.

At S505, in response to determining to trigger registration, the UE provides a further message to the AMF. The further message is provided to the UE via cell 2.

The further message may be part of an MRU procedure. The MRU procedure comprises sending the further message. The further message may be a register request message.

The further message indicates a request for network slice 1 (“slice 1”), and network slice 3 (“slice”). It should be understood that slices 1 and 3 are requested as an example only. In other examples, more or less than two network slices are requested.

At S506, the AMF provides a further response message to the UE, via cell 2. The further response message may be a register accept message.

The further response message comprises a partially rejected NSSAI with slice 3, cell 1 of TA 1. This is because the UE is currently located at/camping in cell 2, wherein cell 2 does not support slice 3.

The further response message also comprises Allowed NSSAI with slice 1. The further response message also indicates that RA1=TA1.

It should be understood that one or more of the steps shown in FIG. 5 may not be performed in some examples, or may be performed in a different order.

In some examples, the UE provides an indication to the network function that the UE supports MRU indicators.

In some examples, the steps of FIGS. 4 and 5 may be combined, or used together. For example, CLRI may be provided as well as an MRU indicator, to a UE.

In some examples, a public land mobile network (PLMN) may implement a resource allocation strategy for a network slice in a cell of a TA where the network slice is not supported. The PLMN may provide some resources, or no resources, to that network slice. When no resources are allocated to the network slice, the radio access network (RAN) may trigger the release of PDU sessions, and may not accept handed-over sessions for the network slice for PDU sessions in connected mode. When some resources are allocated, the PDU sessions of the network slice may be retained (and handed-over), also to cells where the network slice is not supported (i.e. outside the area of service of the network slice). The PLMN may use reporting from the RAN to detect when, in connected mode, the UE is inside or outside of the area of service. For example, for charging purposes, or to let the core network take a decision to retain the PDU session.

One or more of the examples discussed above lead to a number of advantages such as less wasting of resources/reduced resource usage. This is due to unnecessary paging being eliminated when the UE has moved into an area that no longer supports a network slice, and the UE disconnecting from the network slice. This is in comparison to previous system whereby the UE would remain connected to that network slice even when moving to an area that does not support the network slice.

Further advantages include an increased capacity in the network. A network slice may have a maximum number of UEs that can access said network slice at one time. In examples, UEs will disconnect from network slices when the UE is no longer located in an area that supports said network slice. In this way, other UEs can register with said network slice, thus ensuring that the capacity of the slice is fully utilized.

FIG. 6 shows an example method flow performed by an apparatus. The apparatus may be comprised in a user equipment. The apparatus may be for a user equipment. The apparatus may be a user equipment. In other examples, the user equipment may be another user device, or terminal.

In S601, the method comprises receiving, from a network function, first information related to a first area in which a first network slice is supported, wherein the first area is comprised within a tracking area of a registration area of a user equipment.

In S603, the method comprises determining, when the user equipment moves from the first area to a second area within the registration area, whether to trigger a registration based on the first information.

FIG. 7 shows an example method flow performed by an apparatus. The apparatus may be comprised in a network function. The apparatus may be for a network function. The apparatus may be a network function.

In S701, the method comprises determining, based on a received request from a user equipment, that a first network slice is supported in a first area, wherein the first area is comprised within a tracking area of a registration area of the user equipment.

In S703, the method comprises providing, to the user equipment, first information indicating the first area in which the first network slice is supported.

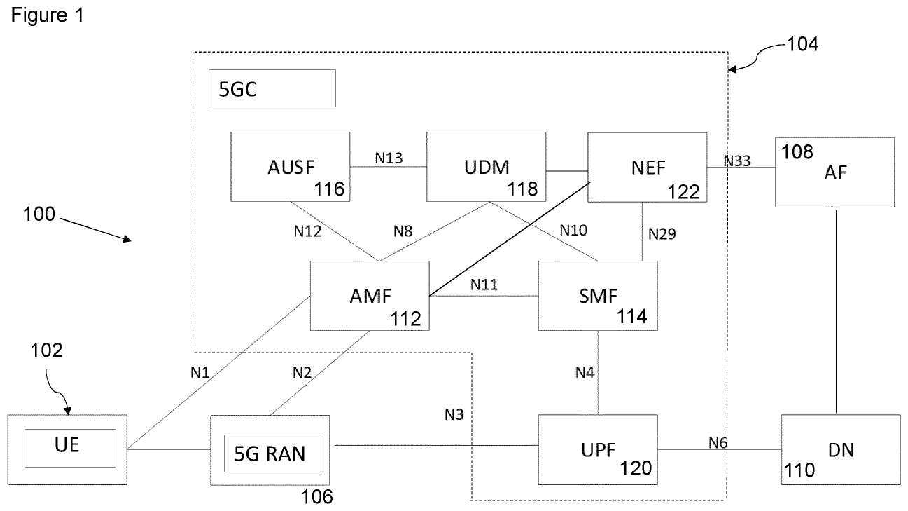

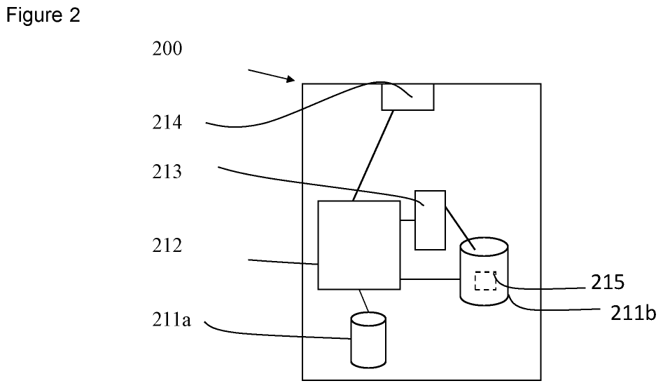

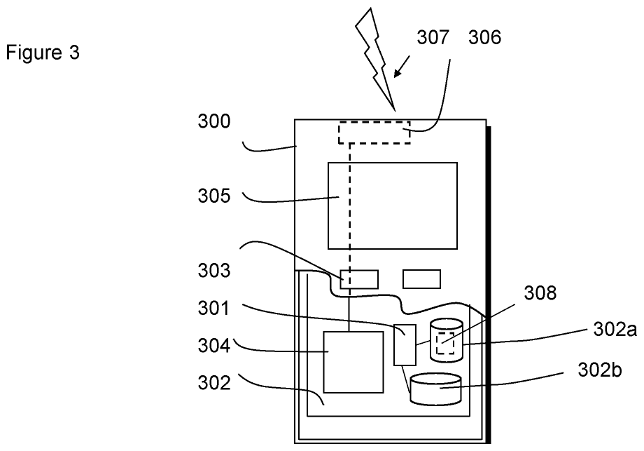

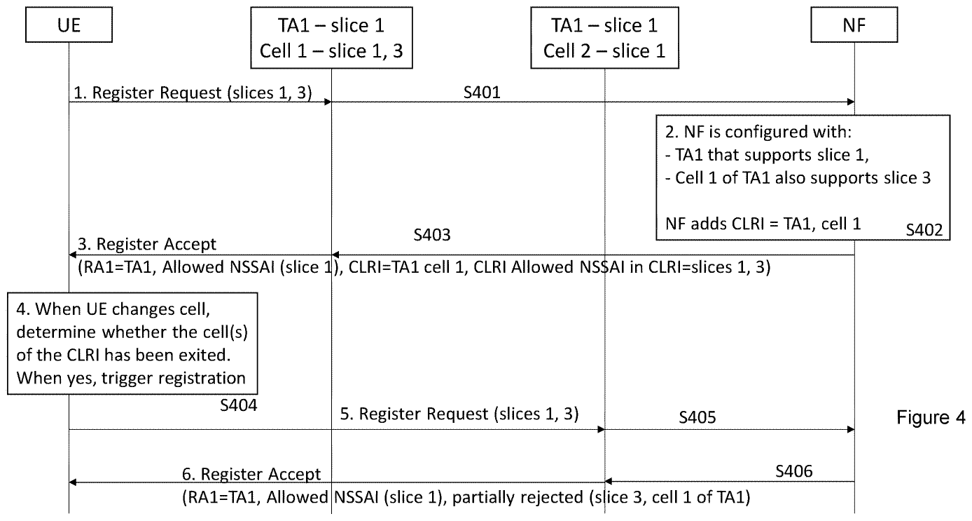

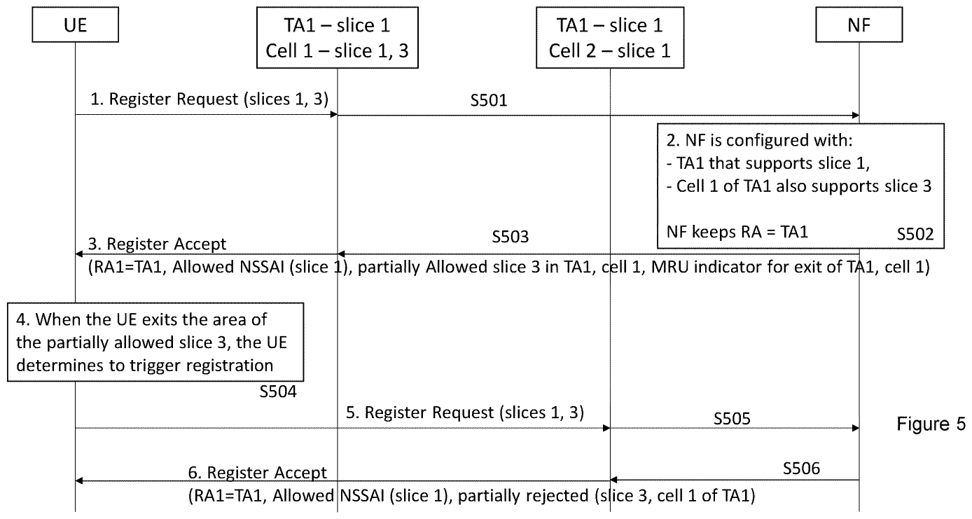

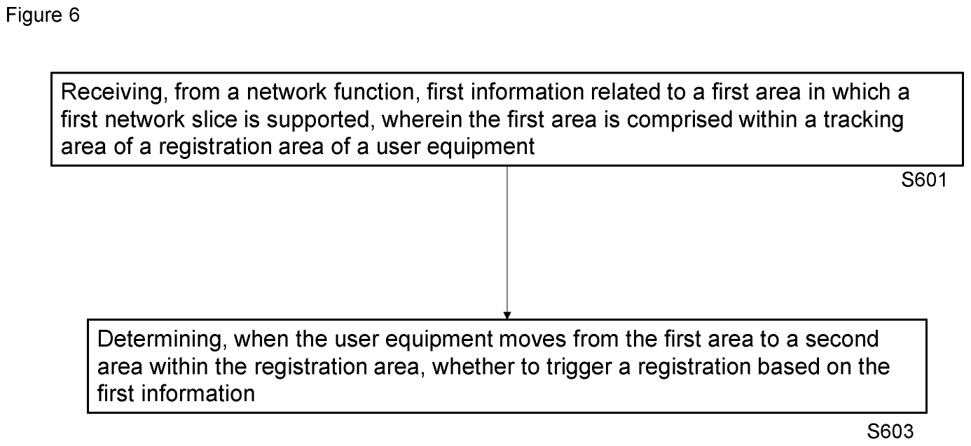

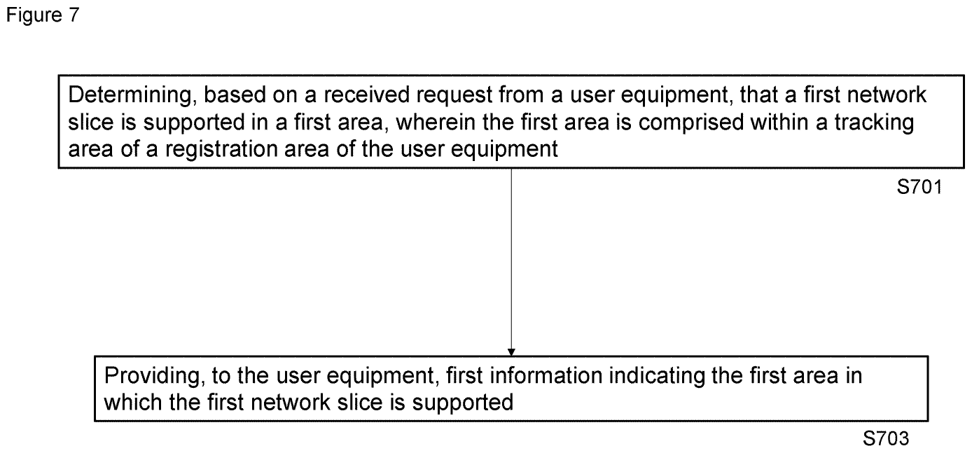

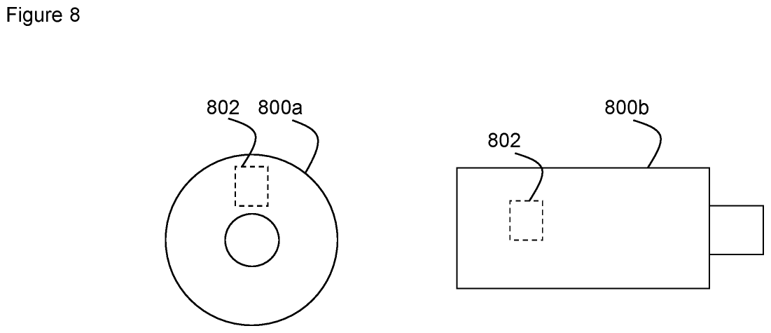

FIG. 8 shows a schematic representation of non-volatile memory media 800a (e.g. computer disc (CD) or digital versatile disc (DVD)) and 800b (e.g. universal serial bus (USB) memory stick) storing instructions and/or parameters 802 which when executed by a processor allow the processor to perform one or more of the steps of the methods of FIG. 6 and FIG. 7.

It is noted that while the above describes example embodiments, there are several variations and modifications which may be made to the disclosed solution without departing from the scope of the present invention.

The examples may thus vary within the scope of the attached claims. In general, some embodiments may be implemented in hardware or special purpose circuits, software, logic or any combination thereof. For example, some aspects may be implemented in hardware, while other aspects may be implemented in firmware or software which may be executed by a controller, microprocessor or other computing device, although embodiments are not limited thereto. While various embodiments may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The examples may be implemented by computer software stored in a memory and executable by at least one data processor of the involved entities or by hardware, or by a combination of software and hardware. Further in this regard it should be noted that any procedures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The term “non-transitory”, as used herein, is a limitation of the medium itself (i.e. tangible, not a signal) as opposed to a limitation on data storage persistency (e.g. RAM vs ROM).

As used herein, “at least one of the following: <a list of two or more elements>” and “at least one of: <a list of two or more elements>” and similar wording, where the list of two or more elements are joined by “and”, or “or”, mean at least any one of the elements, or at least any two or more of the elements, or at least all of the elements.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi core processor architecture, as non-limiting examples.

Alternatively, or additionally some examples may be implemented using circuitry. The circuitry may be configured to perform one or more of the functions and/or method steps previously described. That circuitry may be provided in the base station and/or in the communications device.

As used in this application, the term “circuitry” may refer to one or more or all of the following:
(a) hardware-only circuit implementations (such as implementations in only analogue and/or digital circuitry);
(b) combinations of hardware circuits and software, such as:
   (i) a combination of analogue and/or digital hardware circuit(s) with software/firmware and
   (ii) any portions of hardware processor(s) with software (including digital signal processor(s)), software, and memory(ies) that work together to cause an apparatus, such as the communications device or base station to perform the various functions previously described; and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example integrated device.

The foregoing description has provided by way of exemplary and non-limiting examples a full and informative description of some embodiments. However, various modifications and adaptations may become apparent to those skilled in the relevant arts in view of the foregoing description, when read in conjunction with the accompanying drawings and the appended claims. However, all such and similar modifications of the teachings will still fall within the scope as defined in the appended claims.

1. An apparatus comprising: at least one processor; and at least one memory storing instructions that, when executed by the at least one processor, cause the apparatus at least to perform:
receiving, from a network function, first information related to a first area in which a first network slice is supported, wherein the first area is comprised within a tracking area of a registration area of a user equipment; and
determining, when the user equipment moves from the first area to a second area within the registration area, whether to trigger a registration based on the first information.

2. The apparatus according to claim 1, wherein the first network slice is partially supported within the tracking area of the registration area of the user equipment.

3. The apparatus according to claim 1, wherein the user equipment is camping in the first area when receiving the first information.

4. The apparatus according to claim 1, wherein the determining comprises:
using the first information to determine whether to trigger the registration; and
in response to determining to trigger the registration, providing a register request message to the network function.

5. The apparatus according to any of claims 1, wherein the determining comprises:
when the user equipment moves from a first cell of the first area to a second cell of the second area, determining whether the second cell supports the first network slice based on the first information; and
in response to determining that the second cell does not support the first network slice, providing a register request message to the network function.

6. The apparatus according to claim 1, wherein the first information comprises at least one cell identifier of at least one cell of at least one tracking area within the registration area in which first network slice is supported, wherein the least one cell includes a cell in which the user equipment is camping.

7. The apparatus according to claims 1, wherein the first information comprises at least one other cell identifier of at least one other cell of at least one tracking area within the registration area in which the first network slice is not supported, wherein the user equipment is camping in a cell away from the at least one other cell.

8. The apparatus according to claim 1, wherein the apparatus is further caused to perform: receiving an allowed network slice assistance information including single-network slice assistance information associated with the first network slice.

9. The apparatus according to claim 1, wherein the first network slice is indicated in the first information by single network slice assistance information that is received in a partially allowed single network slice assistance information.

10. The apparatus according to claim 1, wherein the first information comprises: an update indicator, the update indicator causing the user equipment to trigger a registration when the user equipment moves away from the first area.

11. The apparatus according to claim 1, wherein at least one of: the first area comprises at least one cell of the registration area, and the second area comprises at least one further cell of the registration area.

12. The apparatus according to claim 10, wherein the determining comprises:
in response to determining that the user equipment has moved out of the first area and based on the received update indicator, providing a register request message to the network function.

13. The apparatus according to claim 1, wherein the first information is included in one of: a register accept message, a user equipment configuration update message.

14. The apparatus according to claim 1, wherein at least one of: the first area is a first cell of the registration area, and the second area is a second cell of the registration area.

15. The apparatus according to claim 1, wherein the apparatus is further caused to perform:
providing, to the network function, a support indication in a register request message, the support indication indicating that the user equipment supports reception of the first information.

16. The apparatus according to claim 1, wherein one of: the apparatus is for the user equipment, the apparatus is comprised in the user equipment, and the apparatus is the user equipment.

17. An apparatus comprising: at least one processor; and at least one memory storing instructions that, when executed by the at least one processor, cause the apparatus at least to perform:
determining, based on a received request from a user equipment, that a first network slice is supported in a first area, wherein the first area is comprised within a tracking area of a registration area of the user equipment; and
providing, to the user equipment, first information indicating the first area in which the first network slice is supported.

18. The apparatus according to claim 17, wherein the first network slice is partially supported within the tracking area of the registration area of the user equipment.

19. The apparatus according to claim 17, wherein first information is provided to the user equipment while the user equipment is camping in the first area.

20-31. (canceled)

32. A method comprising:
receiving, from a network function, first information related to a first area in which a first network slice is supported, wherein the first area is comprised within a tracking area of a registration area of a user equipment; and
determining, when the user equipment moves from the first area to a second area within the registration area, whether to trigger a registration based on the first information.

33-35. (canceled)
